(19) United States
(12) Patent Application Publication
(10) Pub. No.: US 2009/0278826 A1
(43) Pub. Date: Nov. 12, 2009

(54) APPARATUS FOR PRODUCING EFFECT OF ROTATING CIRCULAR DISPLAY

(76) Inventor: Paul A. Murphy, Hong Kong (HK)

Correspondence Address: BYIP, LTD., P.O. BOX 1484, GENERAL POST OFFICE, HONG KONG, HK

(21) Appl. No.: 12/436,106

(22) Filed: May 5, 2009

Related U.S. Application Data
(60) Provisional application No. 61/051,002, filed on May 6, 2008.

(51) Int. Cl. G09G 5/00

(52) U.S. Cl. 345/204; 345/1.1

(57) ABSTRACT

An apparatus for producing the effect of a rotating circular display includes a plurality of display panels being connected into a polygonal array and respectively comprising a matrix of pixels and a driving circuit being electrically connected to the display panels and configured for selectively illuminating the pixels. The angle between the adjacent display panels in the array is generally equal to or less than about 20 degrees. The distance between adjacent pixels within the same display panel is generally equal to the distance between adjacent pixels across the adjacent display panels.

### CROSS-REFERENCE TO RELATED APPLICATIONS

This application claims the benefit of U.S. Provisional Application No. 61/051,002, filed on May 6, 2008, the contents of which are hereby incorporated by reference.

### FIELD OF THE PATENT APPLICATION

The present patent application generally relates to electronic display systems and more particularly to an apparatus for producing the effect of a rotating circular display.

### BACKGROUND

There are a number of products available on the market today that can produce the effect of a rotating circular display. Many of these products make use of a vertical column of LEDs (light-emitting diodes) mounted on a rotating arm propelled by a motor. Switching the LEDs “on” and “off” with the appropriately timed electrical signals, while the arm is rotating at a constant speed, can create the effect of a circular rotating display.

Circular rotating displays, while being relatively small, are extremely useful in conveying a large amount of text information and can also be viewed from a distance at almost any angle. One of the disadvantages of the currently readily available solutions is that the use of electric motors makes it almost impossible, at least at reasonable cost, to eliminate all mechanical noise and vibration. Such products are not suitable for use in quiet home environments, more specifically, in a bedroom or a study, or for use with audio/video devices, in which case the noise and vibration may degrade the audio quality.

The effect of a rotating display can possibly also be simulated by arranging a matrix array of LEDs in a circle. However, from an electromechanical construction or assembly perspective, such an arrangement is not easy or cost effective to produce.

### SUMMARY

The present patent application is directed to an apparatus for producing the effect of a rotating circular display. In one aspect, the apparatus includes a plurality of display panels being connected into a polygonal array and respectively including a matrix of pixels, and a driving circuit being electrically connected to the display panels and configured for selectively illuminating the pixels. The angle between the adjacent display panels in the polygonal array is generally equal to or less than about 20 degrees. A distance between adjacent pixels within the same display panel is generally equal to a distance between adjacent pixels across the adjacent display panels.

In one embodiment, the apparatus further includes a processor and a storage device. The processor is electrically connected to the driving circuit and the storage device, and configured for retrieving the content to be displayed by the apparatus from the storage device and accordingly controlling the driving circuit to selectively illuminate pixels of the display panels in an appropriate timing.

In another embodiment, each of the display panels further includes a molded housing and a printed circuit board. The pixels are respectively mounted on and electrically connected to the printed circuit board. The molded housing accommodates the pixels and the printed circuit board.

In yet another embodiment, the apparatus further includes a circular lens. The circular lens covers the polygonal array of display panels at the light emitting sides thereof.

### BRIEF DESCRIPTION OF THE DRAWINGS

FIG. 1A is a front view of a number of display panels arranged into a polygonal array in an apparatus according to an embodiment of the present application.

FIG. 1B is a top view of the arrangement of the display panels depicted in FIG. 1A.

FIG. 1C is a side view of the arrangement of the display panels depicted in FIG. 1A.

FIG. 2 is a schematic circuit diagram of two alternate methods of connecting the LED's in display panels depicted in FIG. 1A.

FIG. 3 is a top view of the arrangement of the display panels depicted in FIG. 1A in particular illustrating the angle between adjacent display panels.

FIG. 4 is a perspective view of two adjacent display panels of the apparatus depicted in FIG. 1A, in particular showing the distance between adjacent pixels within the same display panel and the distance between adjacent pixels across the adjacent display panels.

FIG. 5 is a cross-sectional diagram of the display panel depicted in FIG. 1A.

FIG. 6 is a cross-sectional diagram of a display panel of an apparatus according to another embodiment of the present patent application.

FIG. 7A is a front view of a display panel of an apparatus according to yet another embodiment of the present patent application.

FIG. 7B is a side view of the display panel depicted in FIG. 7A.

FIG. 7C is a bottom view of the display panel depicted in FIG. 7A.

FIG. 7D illustrates the column and row arrangement of the pixels of the display panel depicted in FIG. 7A.

### DETAILED DESCRIPTION

Reference will now be made in detail to embodiments of the apparatus for producing the effect of a rotating circular display in the present patent application, examples of which are also provided in the following description. Exemplary embodiments of the apparatus for producing the effect of a rotating circular display disclosed in the present patent application are described in detail, although it will be apparent to those skilled in the relevant art that some features that are not particularly important to an understanding of the apparatus for producing the effect of a rotating circular display may not be shown for the sake of clarity.

Furthermore, it should be understood that the apparatus for producing the effect of a rotating circular display disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

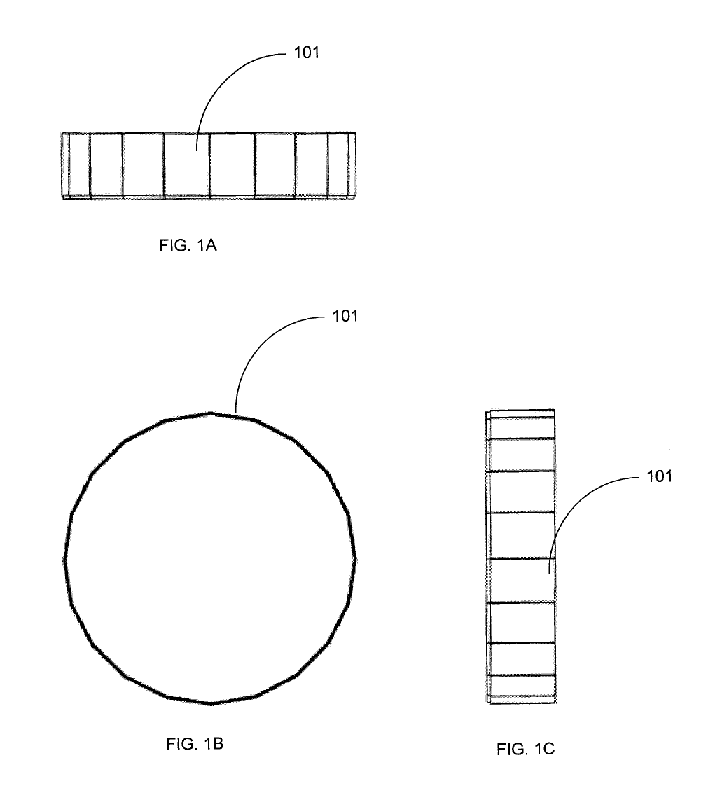

FIG. 1A is a front view of a number of display panels arranged into a polygonal array in an apparatus according to an embodiment of the present application. FIG. 1B is a top view of the arrangement of the display panels depicted in FIG. 1A. FIG. 1C is a side view of the arrangement of the display panels depicted in FIG. 1A. Referring to FIG. 1A, a number of display panels 101 are connected in a closed chain forming a polygonal array of displays. In this embodiment, the display panel 101 is a LED (light-emitting diode) display panel, which includes multiple LEDs disposed thereon. Each LED on the display panel 101 is a pixel of the display. A circular tinted lens (not shown in FIG. 1A, FIG. 1B or FIG. 1C) can be used to cover the polygonal array of the display panels at the light emitting sides of the display panels so as to prevent a viewer from having a clear view of the array, but still to allow the viewer to see the illuminated pixels.

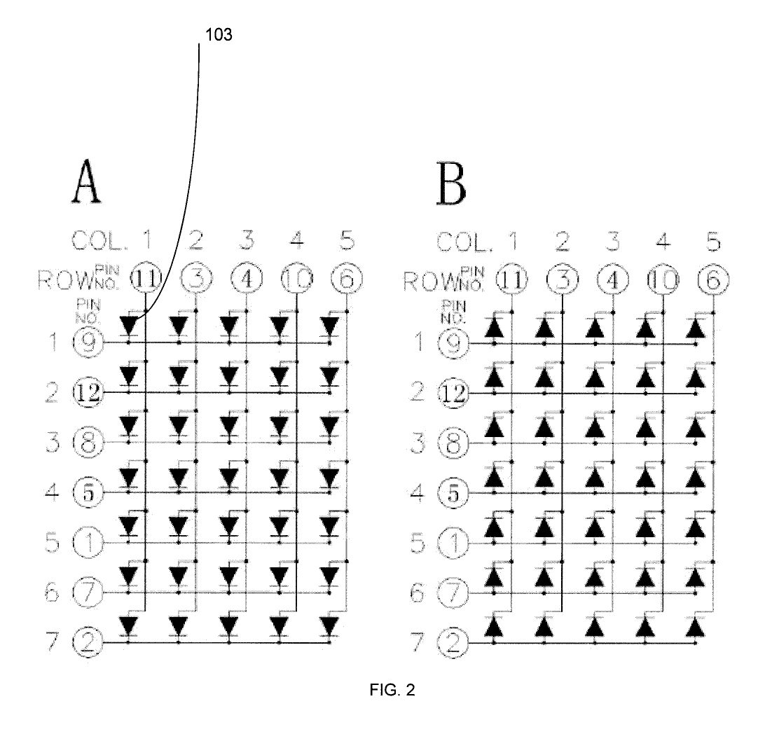

The apparatus in this embodiment is driven by a driving circuit. The driving circuit is electrically connected with the display panels and configured to determine, among all the LEDs at different locations of all the different display panels 101, which LEDs are turned on, that is, illuminated at a given point of time. FIG. 2 is a schematic circuit diagram of two alternate methods of connecting the LED's in display panels depicted in FIG. 1A. Referring to FIG. 2, the LEDs 103 are arranged in 5 columns and 7 rows in each display panel. Each LED 103 is connected between one of the column lines 11, 3, 4, 10 and 6 and one of the row lines 9, 12, 8, 5, 1, 7 and 2. The driving circuit is configured to control the voltages of the column lines and the row lines so as to selectively turn on some of the LEDs 103. The apparatus further includes a processor for controlling the driving circuit and a storage device for storing the content to be displayed. In operation, the processor retrieves the content to be displayed from the storage device and controls the driving circuit to lit specific LEDs in an appropriate timing so that the content is displayed in the polygenic array of display panels and the effect of a rotating circular display is thereby produced.

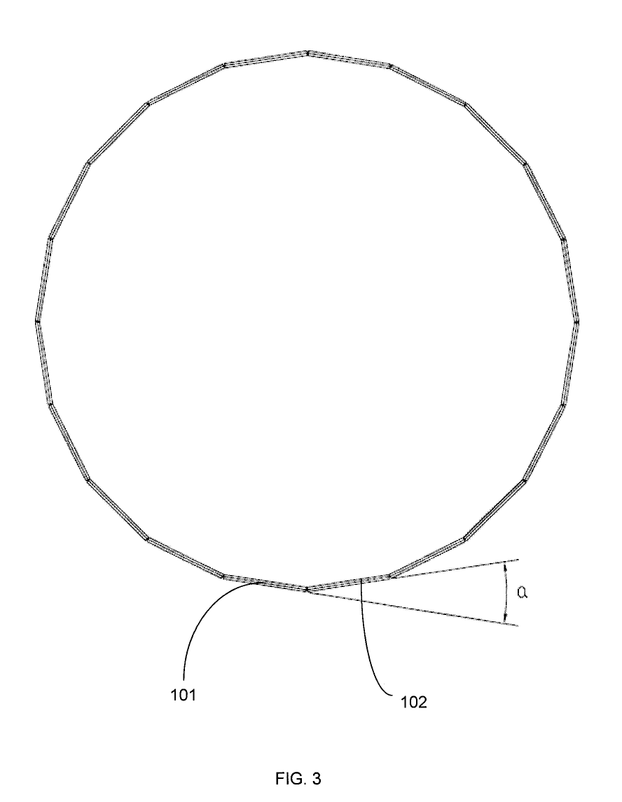

FIG. 3 is a top view of the arrangement of the display panels depicted in FIG. 1A in particular illustrating the angle between adjacent display panels. Referring to FIG. 3, the angle a between the adjacent display panels 101 and 102 is generally equal to or less than about 20 degrees. This requirement makes the total number of the display panels in the complete polygon equal to or greater than: 360/20=18, so that a substantial number of display panels 101 are combined together to produce a visual effect that is sufficiently similar to what a real circular display would produce.

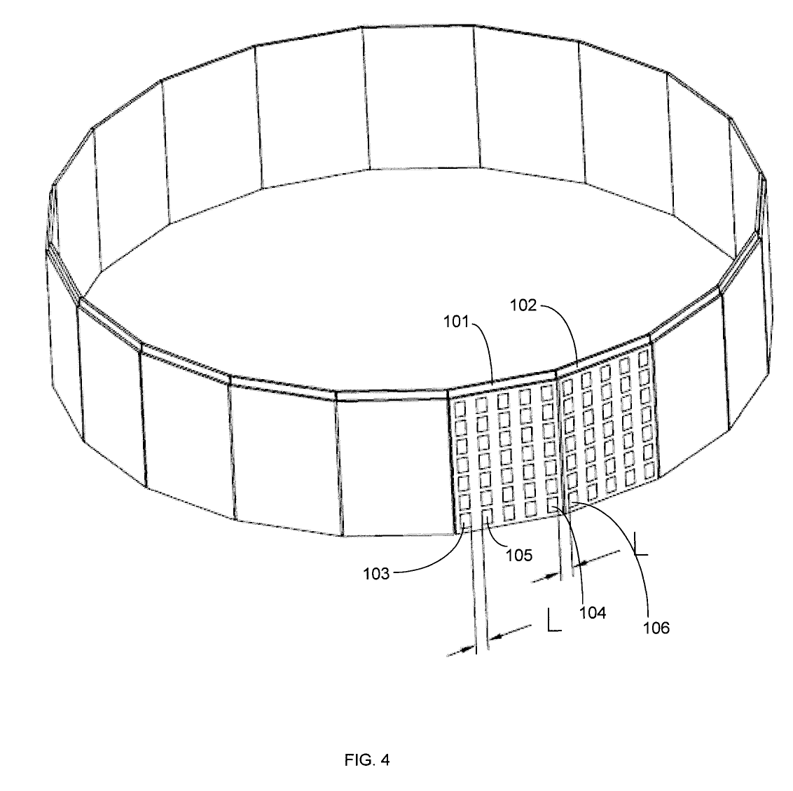

FIG. 4 is a perspective view of two adjacent display panels of the apparatus depicted in FIG. 1A, in particular showing the distance between adjacent pixels within the same display panel and the distance between adjacent pixels across the adjacent display panels. Referring to FIG. 4, the distance between adjacent pixels 103 and 105 within the same display panel 101 and the distance between adjacent pixels 104 and 106 across the adjacent display panels 101 and 102 are both equal to L. Such requirement is imposed to minimize the visual difference between the adjacent display panels 101 and 102 so that from a viewer's perspective, the adjacent display panels 101 and 102 look more like one bigger continuous circular display rather than two smaller distinctive displays, especially when the pixels at various locations of the displays are illuminated (turned on) and turned off at a predetermined refresh rate and the apparatus is being viewed at a reasonable distance.

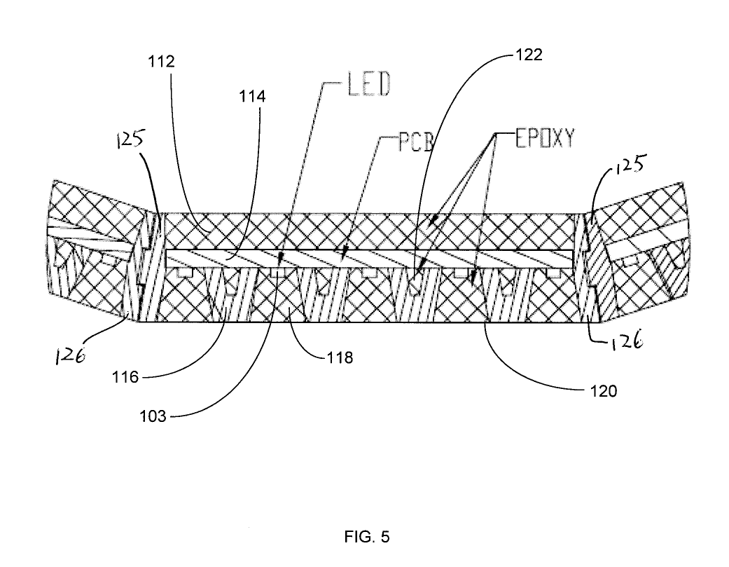

FIG. 5 is a cross-sectional diagram of the display panel depicted in FIG. 1A. Referring to FIG. 5, the display panel further includes a plastic molded housing 112 and a PCB (printed circuit board) 114. The PCB 114 is bonded to the plastic molded housing 112 by epoxy. The LEDs 103 are mounted onto the PCB 114 and electrically connected to the driving circuit through the PCB 114. The plastic molded housing 112 includes multiple separators 116. The separators 116 are respectively disposed between every two adjacent LEDs 103 on the PCB 114 so that a LED chamber 118 is defined thereby corresponding to each LED 103. The LED chamber 118 is filled with a light transmissible sealing material, such as epoxy, so as to defuse the light emitted by the corresponding LED 103. It is noted that the light emitting side 120 of the display panel is flat. This is because during the manufacturing process the display panel needs to be laid on a flat surface while the epoxy in the display panel is being cured. It is also noted that a gap 122 filled with epoxy is formed in the separator 116 to keep the thicknesses of the plastic walls even for good mold flow and to eliminate structure sinking during the manufacturing process. The cross section also shows the method of interlocking the display panels in this embodiment. Each display module molding has a male 125 and female 126 interlocking mechanism on either side of the display panel. These ensure the regular form of the polygonal array, ensure the correct inter-pixel spacing between adjacent panes, and also lock the panels together to eliminate movement of vibration.

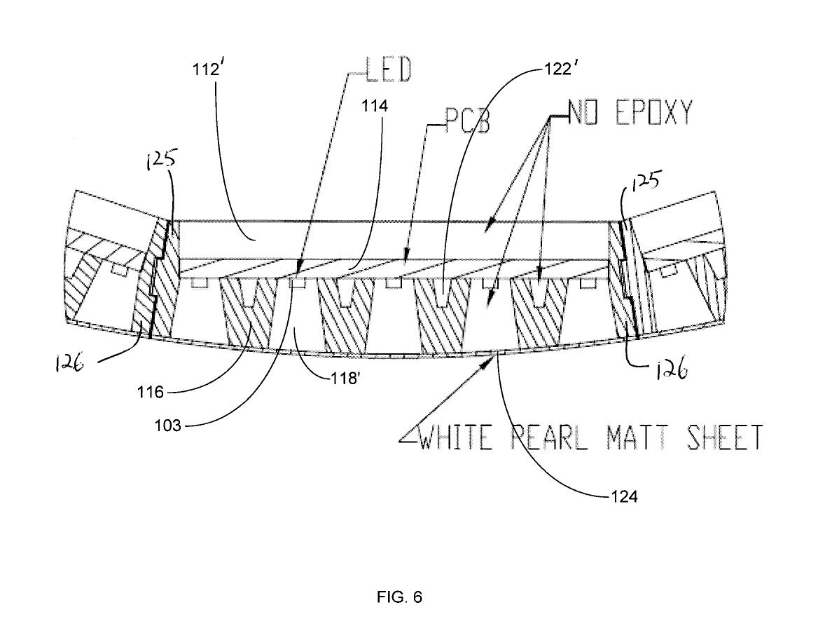

FIG. 6 is a cross-sectional diagram of a display panel of an apparatus according to another embodiment of the present patent application. The difference between this embodiment and the previous embodiment is that in this embodiment, no epoxy is filled in the LED chamber 118′ and the gap 122′. Because no epoxy curing process is required in the manufacturing process, a curved sheet 124, such as a white pearl matt sheet 124 can be used to wrap the light emitting side of the display panel. This embodiment also uses the same interlocking mechanism 125 and 126 between panels as used in the embodiment shown in FIG. 5.

It is understood that in the above embodiments the LED 103 can alternatively be replaced by other light sources such as a LCD (liquid crystal display) module. It is further understood that the pixel elements (LEDs or LCD modules) can be mounted to the display panels in other ways.

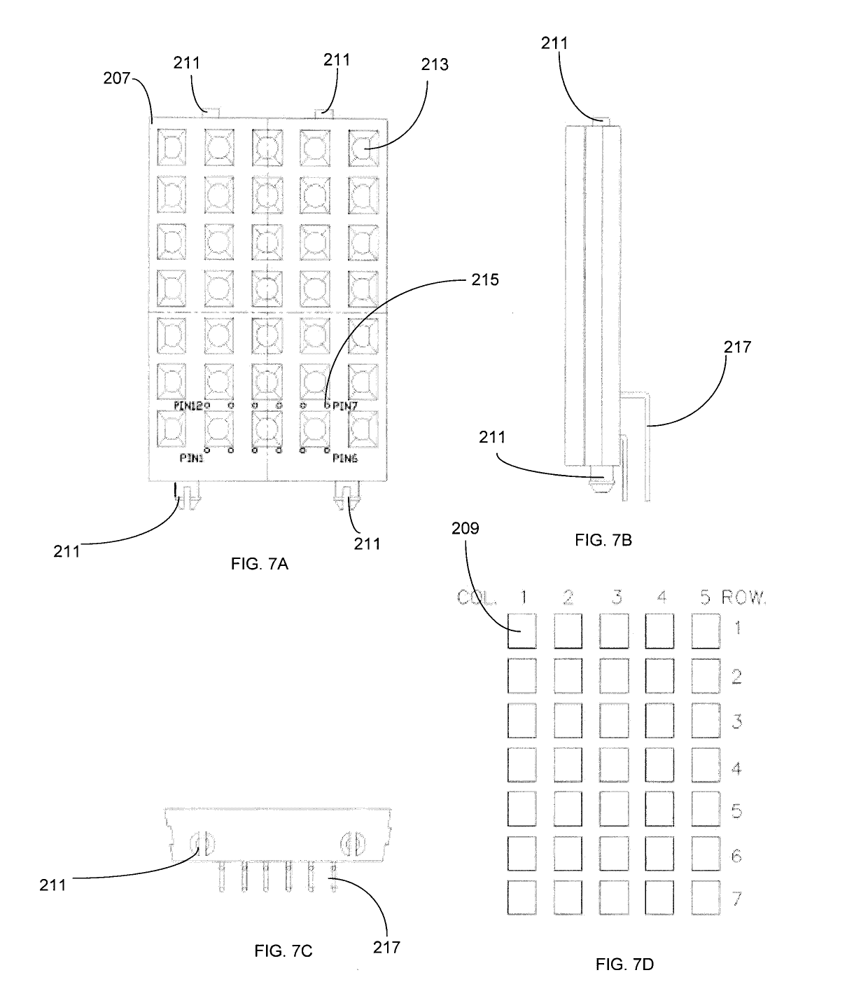

FIG. 7A is a front view of a display panel of an apparatus according to yet another embodiment of the present patent application. FIG. 7B is a side view of the display panel. FIG. 7C is a bottom view of the display panel. FIG. 7D illustrates the column and row arrangement of the pixels of the display panel. Referring to FIG. 7A through FIG. 7D, each display panel includes a plastic molded housing 207, a printed circuit board (PCB) (not shown in FIG. 7A) encapsulated in the plastic molded housing 207 and multiple LCD modules 209 functioning as individual pixels. The plastic molded housing 207 includes multiple fixture members 211 for mounting the display panel to the apparatus so that the polygonal display chain can be formed, multiple recesses 213 formed on the plastic molded housing 207 and multiple mounting holes 215 formed around each recess 213. The recesses 213 are arranged in a number of columns and rows. In this embodiment, there are five columns and seven rows of recesses 213. Each recess 213 is configured for providing a mechanical support for a LCD module 209. Each LCD module 209 is mounted onto the corresponding recess 213 of the plastic molded housing 207 by pegs fastened into the mounting holes 215. The LCD module 209 is electrically connected to the PCB. The PCB has leads 217 for electrically connecting the PCB and the driving circuit (not shown in FIG. 7A through FIG. 7D).

It is understood that in this embodiment the LCD module 209 can alternatively be replaced by other light sources such as a LED. It is further understood that the pixel elements (LCD modules or LEDs) can be mounted to the display panels in other ways.

While the present patent application has been shown and described with particular references to a number of embodiments thereof, it should be noted that various other changes or modifications may be made without departing from the scope of the present invention.

What is claimed is:

1. An apparatus for producing the effect of a rotating circular display comprising:
a plurality of display panels being connected into a polygonal array and respectively comprising a matrix of pixels, a molded housing and a printed circuit board, the pixels being respectively mounted on and electrically connected to the printed circuit board, and the molded housing accommodating the pixels and the printed circuit board; and
a driving circuit being electrically connected to the display panels and configured for selectively illuminating the pixels; wherein:
the printed circuit board and the molded housing form a chamber enclosing each pixel, the chamber being filled with a light transmissible sealing material; and
an angle between adjacent display panels in the polygonal array is generally equal to or less than about 20 degrees, and a distance between adjacent pixels within the same display panel is generally equal to a distance between adjacent pixels across the adjacent display panels.

2. The apparatus of claim 1, wherein a light emitting side of the display panel is flat.

3. The apparatus of claim 1, wherein the pixel is a light-emitting diode (LED) or a liquid crystal display (LCD) module.

4. The apparatus of claim 1, further comprising a circular lens, the circular lens covering the polygonal array of display panels at light emitting sides thereof.

5. An apparatus for producing the effect of a rotating circular display comprising:
a plurality of display panels being connected into a polygonal array and respectively comprising a matrix of pixels, a molded housing and a printed circuit board, the pixels being respectively mounted on and electrically connected to the printed circuit board, and the molded housing accommodating the pixels and the printed circuit board; and
a driving circuit being electrically connected to the display panels and configured for selectively illuminating the pixels; wherein:
the printed circuit board and the molded housing form a chamber enclosing each pixel, the chamber being filled with air; and
an angle between adjacent display panels in the array is generally equal to or less than about 20 degrees, and a distance between adjacent pixels within the same display panel is generally equal to a distance between adjacent pixels across the adjacent display panels.

6. The apparatus of claim 5, wherein a light emitting side of the display panel is wrapped by a curved sheet.

7. The apparatus of claim 5, wherein the pixel is a light-emitting diode (LED) or a liquid crystal display (LCD) module.

8. The apparatus of claim 5, further comprising a circular lens, the circular lens covering the polygonal array of display panels at light emitting sides thereof.

9. An apparatus for producing the effect of a rotating circular display comprising:
a plurality of display panels being connected into a polygonal array and respectively comprising a matrix of pixels; and
a driving circuit being electrically connected to the display panels and configured for selectively illuminating the pixels; wherein:
an angle between adjacent display panels in the polygonal array is generally equal to or less than about 20 degrees, and a distance between adjacent pixels within the same display panel is generally equal to a distance between adjacent pixels across the adjacent display panels.

10. The apparatus of claim 9, wherein the apparatus further comprises a processor and a storage device, the processor being electrically connected to the driving circuit and the storage device, and configured for retrieving contents to be displayed by the apparatus from the storage device and accordingly controlling the driving circuit to selectively illuminate pixels of the display panels in an appropriate timing.

11. The apparatus of claim 9, wherein the pixel is a light-emitting diode (LED) or a liquid crystal display (LCD) module.

12. The apparatus of claim 9, wherein each of the display panels further comprises a molded housing and a printed circuit board, the pixels being respectively mounted on and electrically connected to the printed circuit board, and the molded housing accommodating the pixels and the printed circuit board.

13. The apparatus of claim 12, wherein the printed circuit board and the molded housing form a chamber enclosing each pixel, the chamber is filled with a light transmissible sealing material and a light emitting side of the display panel is flat.

14. The apparatus of claim 12, wherein the printed circuit board and the molded housing form a chamber enclosing each pixel, the chamber is filled with air and a light emitting side of the display panel is wrapped by a curved sheet.

15. The apparatus of claim 14, wherein the curved sheet comprises a white pearl matt sheet.

16. The apparatus of claim 12, wherein the molded housing comprises a plurality of recesses respectively corresponding to the pixels, and a plurality of mounting holes formed around each recess, each pixel being mounted onto the corresponding recess by pegs fastened into the mounting holes.

17. The apparatus of claim 12, wherein the molded housing comprises a plurality of fixture members for mounting the display panel to the apparatus so as to form the polygonal array of the display panels.

18. The apparatus of claim 9, further comprising a circular lens, the circular lens covering the polygonal array of display panels at light emitting sides thereof.

19. The apparatus of claim 9, wherein the adjacent display panels are interlocked with each other.

20. The apparatus of claim 19, wherein the adjacent display panels are interlocked with each other by a male and female interlocking mechanism.
